(19) United States
(12) Patent Application Publication
(10) Pub. No.: US 2020/0276653 A1
(43) Pub. Date: Sep. 3, 2020

(54) Tool Holder For Ultrasonic Machining

(71) Applicant: X'POLE PRECISION TOOLS INC., Taoyuan City (TW)

(72) Inventor: Peter CHEN, Taoyuan City (TW)

(21) Appl. No.: 16/289,618

(22) Filed: Feb. 28, 2019

(51) Int. Cl. B23B 31/26

(52) U.S. Cl. CPC B23B 31/26; B23B 2231/42

(57) ABSTRACT

A tool holder for ultrasonic machining used in a machine which supplies power via a spindle is provided with a connector received in the spindle; a conductive ring disposed on the connector and electrically connected to the spindle so as that power is configured to supply to the tool holder; a tool mounting member including an axial hole for fastening a portion of a tool; and an oscillator for producing ultrasonic vibration disposed in the tool mounting member, the oscillator for producing ultrasonic vibration electrically connected to the conductive ring so that power supplied to the oscillator for producing ultrasonic vibration is configured to produce ultrasonic vibration of high frequency. The produced ultrasonic vibration of high frequency is transmitted to the tool via the axial hole.

### BACKGROUND OF THE INVENTION

### 1. Field of the Invention

The invention relates to relates to tool holders and more particularly to a tool holder for ultrasonic machining.

### 2. Description of Related Art

Conventional ultrasonic machining (USM) involves mounting an electronic oscillator on a spindle. The oscillator produces an alternating current oscillating at a high frequency in the ultrasonic range. A transducer converts the oscillating current to a mechanical vibration which is transmitted to a tool held by a holder. USM can remove material from the surface of a part through high frequency, low amplitude vibrations of the tool against the material surface in the presence of fine abrasive particles. USM is typically used on brittle materials as well as materials with a high hardness due to the microcracking mechanics.

The tool travels vertically or orthogonal to the surface of the part. The fine abrasive grains are mixed with water to form slurry that is distributed across the part and the tip of the tool. Typical grain sizes of the abrasive material are very small so as to produce smoother surface finishes.

In an ultrasonic machining process, the oscillator produces an alternating current oscillating at a high frequency in the ultrasonic range. The transducer converts the oscillating current to a mechanical vibration which is transmitted to the tool held by the holder. However, components may collide one another resulting in undesired vibration which may interfere with the high frequency vibration. An in turn, it may adversely affect precision of the workpiece.

Elongated tool holders are disclosed by U.S. Pat. Nos. 1,502,528, 2,716,030 and 8,821,084. For high length to diameter (L/D) ratio, the precision of the workpiece may be very low or even be impossible of being machined due to rigidity of the material of the tool holder. These are problems encountered by the conventional ultrasonic machines. Further, in USM the path of transmitting vibration may be very long. And in turn, it may cause strong interference to undesirably vibrate the tool holder. Furthermore, the maximum amplitude of the vibration frequencies cannot be controlled to focus on the tip of the tool. And in turn, the cutting effect is adversely affected. Also, smoothness and quality of the workpiece are low. To the worse, the ultrasonic machines are damaged.

Thus, the need for improvement still exists.

### SUMMARY OF THE INVENTION

It is therefore one object of the invention to provide a tool holder for ultrasonic machining wherein an oscillator for producing ultrasonic vibration is disposed in the tool mounting member so that the path for transmitting the vibration of high frequency can be greatly decreased, undesired vibration to the tool holder by the high frequency vibration can be eliminated, and smoothness and quality of the workpiece are improved.

It is another object of the invention to provide a tool holder for ultrasonic machining wherein the inadequate rigidity of the material of the conventional tool holder having a high L/D ratio is improved, and the high L/D ratio is significantly decreased. As shown in FIG. 3, the length to diameter ratio before the installation of the oscillator for producing ultrasonic vibration labeled L1/D is decreased to L/D after the installation of the oscillator for producing ultrasonic vibration. Further, the provision of at least one sleeve can lengthen the tool holder while the L/D is fixed irrespective of the value of L1.

It is still another object of the invention to provide a tool holder for ultrasonic machining wherein the length of the tool holder can be changed by providing at least one sleeve interconnecting a connector and a tool mounting member.

For achieving above an other objects of the invention, there is provided a tool holder for ultrasonic machining used in a machine which supplies power via a spindle, comprising a connector received in the spindle; a conductive ring disposed on the connector and electrically connected to the spindle so as that power is configured to supply to the tool holder; a tool mounting member including an axial hole for fastening a portion of a tool; and an oscillator for producing ultrasonic vibration disposed in the tool mounting member, the oscillator for producing ultrasonic vibration electrically connected to the conductive ring so that power supplied to the oscillator for producing ultrasonic vibration is configured to produce ultrasonic vibration of high frequency; wherein the produced ultrasonic vibration of high frequency is transmitted to the tool via the axial hole.

Preferably, the tool mounting member further comprises a flexible chuck having the axial hole of the tool mounting member disposed therein, the flexible chuck including a plurality of lengthwise parallel slits each having an open end, and a plurality of latches each disposed between two adjacent ones of the slits; and a fastener disposed on one end of the flexible chuck so that a force exerted upon the flexible chuck is configured to flexibly deform the latches to fasten the tool in the flexible chuck.

Preferably, there is further provided an axial channel in the connector communicating with inside of the tool mounting member, and a wire having one end electrically connected to the oscillator and the other end electrically connected to the conductive ring by passing through the axial channel.

Preferably, there is further provided at least one sleeve interconnecting the connector and the tool mounting member.

Preferably, each sleeve includes a projection at one end and a receptacle at the other end so that the at least one sleeve is configured to complimentarily attach to both the connector and the tool mounting member.

### BRIEF DESCRIPTION OF THE DRAWINGS

The invention, as well as its many advantages, may be further understood by the following detailed description and drawings in which:

FIG. 1 is a longitudinal sectional view of a tool holder for ultrasonic machining according to a first preferred embodiment of the invention;

FIG. 2 is a detailed view of the area in a rectangle A of FIG. 1; and

FIG. 3 is a longitudinal sectional view of a tool holder for ultrasonic machining according to a second preferred embodiment of the invention.

### DETAILED DESCRIPTION OF THE INVENTION

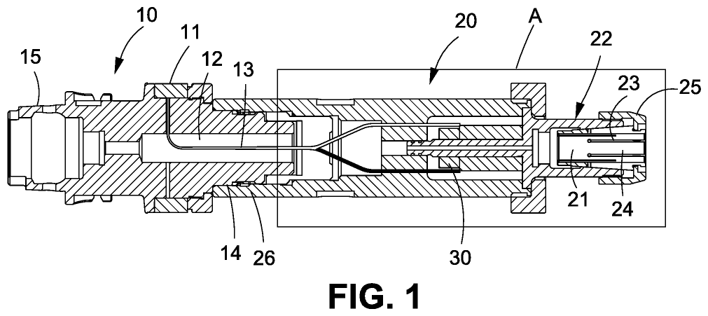

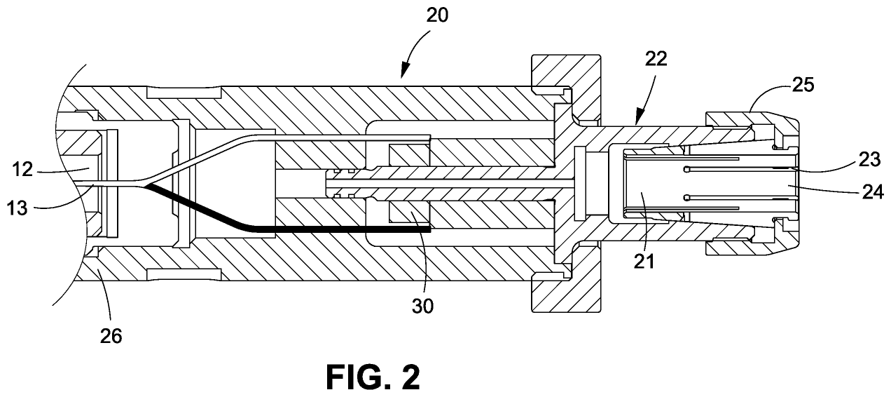

Referring to FIGS. 1 and 2, a tool holder for ultrasonic machining according to a first preferred embodiment of the invention is used in a machine which supplies power via a spindle (not shown). The tool holder for ultrasonic machining comprises a connector 10 received in the spindle, a conductive ring 11 disposed on the connector 10 and electrically connected to the spindle so that power may be supplied to the tool holder; a tool mounting member 20 including an axial hole 21 for fastening a portion of a tool (e.g., tool handle but not shown); and an oscillator 30 for producing ultrasonic vibration disposed in the tool mounting member 20, the oscillator 30 for producing ultrasonic vibration electrically connected to the conductive ring 11 so that power may be supplied to the oscillator 30 for producing ultrasonic vibration. The produced vibration of high frequency is transmitted to the tool via the axial hole 21. As a result, the path for transmitting the vibration of high frequency can be greatly decreased.

The connector 10 has a stepped-diameter outer surface 15 which is configured to receive in the spindle of a machine. Thus, the tool holder may be aligned with the spindle to be secured together. The connector 10 is designed to allow the tool holder to be used in an automatic tool changing system.

The tool mounting member 20 is substantially cylindrical and includes a flexible chuck 22 having the axial hole 21 formed therein, a plurality of lengthwise parallel slits 23 each having an opening at one end, a plurality of latches 24 each disposed between two adjacent ones of the slits 23, and a fastener 25 disposed on one end of the chuck 22 to exert a force to flexibly deform the latches 24 so that a tool (not shown) disposed in the chuck 22 can be fastened. The fastening of the tool by using the flexible chuck 22 is one of a plurality of fastening methods. Those skilled in the art may be aware of other fastening methods.

In the first preferred embodiment of the invention, there is further provided an axial channel 12 in the connector 10 communicating with inside of the tool mounting member 20. A wire 13 having one end electrically connected to the oscillator 30 in the tool mounting member 20 and the other end electrically connected to the conductive ring 11 by passing through the channel 12. A non-contact conductive connection (e.g., electromagnetic induction) can be implemented between the conductive ring 11 and the spindle of the machine. Alternatively, a two-terminal conductive contact between the conductive ring 11 and the spindle of the machine can be implemented. As a result, power is supplied to the conductive ring 11 which is served as a carbon brush.

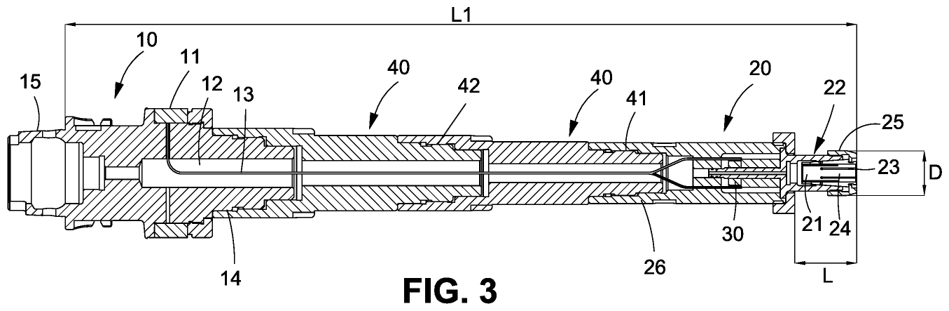

Referring to FIG. 3, a tool holder for ultrasonic machining according to a second preferred embodiment of the invention is shown. The characteristics of the second preferred embodiment are substantially the same as that of the first preferred embodiment except the following: a plurality of (e.g., two) sleeves 40 are disposed between the connector 10 and the tool mounting member 20. Each sleeve 40 includes a projection 41 at one end and a receptacle 42 at the other end so that the projection 41 of one sleeve 40 can be complimentarily attaching to the receptacle 42 of the other sleeve 40. A protrusion 14 is provided at one end of the connector 10 for complimentarily attaching to the receptacle 42 of one sleeve 40, and a cavity 26 is provided at the other end of the tool mounting member 20 for complimentarily attaching to the projection 41 of the other sleeve 40. As a result, the connector 10, the sleeves 40 and the tool mounting member 20 are secured together. The number of the sleeves 40 can be increased or decreased depending applications. Thus, the length of the tool holder can be adjusted.

It is envisaged by the tool holder for ultrasonic machining of the invention that the oscillator for producing ultrasonic vibration is disposed in the tool mounting member so that the path for transmitting the vibration of high frequency can be greatly decreased. Further, undesired vibration to the tool holder by the high frequency vibration may be eliminated. Furthermore, the inadequate rigidity of the material of the conventional tool holder having a high L/D ratio is improved. In addition, smoothness and quality of the workpiece are improved. Additionally, the provision of the sleeves may lengthen the tool holder if such need arises.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A tool holder for ultrasonic machining used in a machine which supplies power via a spindle, comprising:
a connector received in the spindle;
a conductive ring disposed on the connector and electrically connected to the spindle so as that power is configured to supply to the tool holder;
a tool mounting member including an axial hole for fastening a portion of a tool; and
an oscillator for producing ultrasonic vibration disposed in the tool mounting member, the oscillator for producing ultrasonic vibration electrically connected to the conductive ring so that power supplied to the oscillator for producing ultrasonic vibration is configured to produce ultrasonic vibration of high frequency;
wherein the produced ultrasonic vibration of high frequency is transmitted to the tool via the axial hole.

2. The tool holder for ultrasonic machining of claim 1, wherein the tool mounting member further comprises a flexible chuck having the axial hole of the tool mounting member disposed therein, the flexible chuck including a plurality of lengthwise parallel slits each having an open end, and a plurality of latches each disposed between two adjacent ones of the slits; and a fastener disposed on one end of the flexible chuck so that a force exerted upon the flexible chuck is configured to flexibly deform the latches to fasten the tool in the flexible chuck.

3. The tool holder for ultrasonic machining of claim 1, further comprising an axial channel in the connector communicating with inside of the tool mounting member, and a wire having one end electrically connected to the oscillator and the other end electrically connected to the conductive ring by passing through the axial channel.

4. The tool holder for ultrasonic machining of claim 1, further comprising at least one sleeve interconnecting the connector and the tool mounting member.

5. The tool holder for ultrasonic machining of claim 4, wherein each of the at least one sleeve includes a projection at one end and a receptacle at the other end so that the at least one sleeve is configured to complimentarily attach to both the connector and the tool mounting member.
